(19) United States
(12) Patent Application Publication
(10) Pub. No.: US 2022/0403563 A1
(43) Pub. Date: Dec. 22, 2022

(54) IMPREGNATED YARN, RIBBED THIN-WALLED COMPOSITE PRODUCT COMPRISING SUCH AN IMPREGNATED YARN, AND METHOD FOR MANUFACTURING THIS YARN AND THIS COMPOSITE PRODUCT

(71) Applicant: BCOMP SA, Fribourg (CH)

(72) Inventors: Julien RION, Vuisternens-devant-Romont (CH); Reto AEBISCHER, Fribourg (CH); Milos JERINIC, St-Légier-La Chiésaz (CH); Christian RYTKA, Bad Säckingen (DE); David BOTOR, Döttingen (CH); Kunal MASANIA, Netherlands AX Oegstgeest (CH)

(21) Appl. No.: 17/776,469

(22) PCT Filed: Nov. 13, 2020
(86) PCT No.: PCT/IB2020/060695

§ 371 Date: May 12, 2022

(30) Foreign Application Priority Data
Nov. 15, 2019 (FR) FR1912815

(51) Int. Cl. D02G 3/40; D06B 3/06; D02G 3/44; D02G 3/38; B29B 15/12; B29C 70/24; B29C 70/42

(52) U.S. Cl. CPC D02G 3/404; D06B 3/06; D02G 3/447; D02G 3/38; B29B 15/122; B29C 70/24; B29C 70/42; B29K 2311/10

(57) ABSTRACT

The invention relates to an impregnated yarn, a ribbed thin-walled composite product comprising such an impregnated yarn, and a method of making them. Such an impregnated yarn (10d; 10e) comprises at least two continuous strands (10a; 10b) comprising plant fibers (11), said strands (10a; 10b) being impregnated with thermoplastic material (12a) in at least 60% of their volume, each of said strands (10a; 10b) being individually twisted and all of said strands (10a; 10b) also being twisted in a configuration (10d) held by the thermoplastic material (12a).

### TECHNICAL BACKGROUND

The present invention relates to the field of rib-reinforced thin-walled composite products resulting from yarns, as well as to impregnated yarns for use in the manufacture of such ribbed thin-walled composite products.

Such thin-walled composites are typically used to form a part with improved mechanical properties while keeping the weight of the part low.

### STATE OF THE ART

If it is desired to reinforce the thin-walled composite product in bending, but also in compression, it is known to provide protruding reinforcements in the form of a ribbed network or grid as in WO2017099585 in which these ribs are formed by molding above and/or below the base plate.

Certain types of thin-walled composite products are known from EP2648890, in particular with yarns of a first thickness and yarns of a second thickness greater than the first thickness and which serve as reinforcement forming ribs on one of the faces of the thin-walled composite product. These yarns of the second thickness are composed of twisted vegetable fibers, this twisting providing in particular a better resistance to compression of these yarns of the second thickness.

Document WO2019087141 relates to a method of impregnating a grid formed from an assembly of yarns with polymer, which improves the quality of the impregnation, with the objective of improving the flexural properties of a thin-walled composite product comprising this grid on a flat base support, such as a mat. To this end, polymer particles are sprinkled on one side of a lattice of interwoven yarns, in order to obtain a grid with a greater quantity of polymer on one side, which in addition lightens the thin-walled composite product comprising such a grid. However, this method is not suitable when a high mechanical performance impregnated yarn is desired due to the very partial impregnation of the yarns of the lattice.

EP2813607A1 describes the passage of fiber strands through an impregnation unit comprising a bath of liquid thermoplastic polymer, to form an impregnated yarn. It turns out that in practice, simply passing through a liquid polymer bath does not ensure total and perfect impregnation of the fiber strand in its entire volume, but a very partial impregnation on the surface of the fiber strand. This random and insufficient impregnation does not guarantee optimized and reproducible properties for the reinforcing yarns within the thin-walled composite product.

### BRIEF SUMMARY OF THE INVENTION

One of the aims of the present invention is to provide a solution which allows to obtain an impregnated yarn for which the impregnation of the fibers is improved, whereby the mechanical properties of this impregnated yarn are increased.

Another aim of the invention is to provide a process for manufacturing an impregnated yarn as well as the impregnated yarn resulting from this manufacturing process which are free of the limitations of known manufacturing processes and impregnated yarns.

Another aim of the invention is to provide a method of manufacturing a ribbed thin-walled composite product as well as the ribbed thin-walled composite resulting from this manufacturing process that are free of the limitations of known manufacturing processes and thin-walled composites.

Another aim of the invention is to provide a method of making a thin-walled composite product reinforced with ribs formed by yarns forming a ribbed thin-walled composite product improved over the prior art.

According to the invention, these aims are achieved in particular by means of a process for manufacturing an impregnated yarn from at least one strand comprising vegetable fibers, in which the following steps are implemented:

providing at least two continuous strands comprising vegetable fibers,
providing an impregnation tank delimiting a sinuous passage between an inlet and an outlet,
feeding the tank with a bath of thermoplastic polymer material in the molten state filling said passage permanently,
arranging said strands in such a way that they are separated from each other upstream of the impregnation tank, that they enter the impregnation tank through said inlet, that they simultaneously follow the passage while being immersed in the thermoplastic material in the liquid state and having at least one zone of contact with one face of the passage, and that they exit the impregnation tank through said exit, and
impregnating the strand by continuously advancing said strand so as to form a strand impregnated with the thermoplastic material, whereby an impregnated yarn is formed;
in which each of the said strands has a twist T1 along a first orientation as they pass through the impregnation tank 20, and
in which, after the impregnation step, a yarn twisting step is also carried out, during which an overall twist corresponding to a twist T2 between them of all the strands is performed, downstream of the impregnation tank, while the thermoplastic material is still in the liquid state, whereby the thermoplastic material creates a bond between the strands in their twisted together state, resulting in the formation of an impregnated and twisted yarn, and wherein said overall twist T2 is carried out along a second orientation different from the first orientation.

This solution has the advantage over the prior art of allowing good impregnation of the fibers by the thermoplastic material, and in particular of not obtaining an impregnated yarn in which only the surface portion of the strands is impregnated, without systematically impregnating the core of the strands and the impregnated yarn resulting from this process.

Such an impregnated yarn resulting from the manufacturing process according to the invention has a better mechanical strength due to this improved impregnation, and in particular a more consequent impregnation, in particular by reaching the fibers of the central portion of the strand or strands (or filament(s)) which form(s) the yarn, which thus allows an improved impregnation of the yarn itself thus obtained. A greater proportion of the volume of each strand is impregnated by the thermoplastic material, which results in impregnation of a greater proportion of the volume of the entire yarn.

It is in particular because of the contact with surfaces of the impregnation tank during the passage of the strand or strands in the bath of liquid thermoplastic material, that this good impregnation is ensured, because by rubbing against hard surfaces, the strand or strands are flattened, which allows, by this opening of the strand or strands, an unfolding of the fibers and thus the bringing in direct contact between all or the majority of the fibers of each strand and the liquid thermoplastic material. The contact with the walls of the tank delimiting the passage also creates a local overpressure which forces the thermoplastic material to penetrate the strand, and to coat more or even all of the fibers of the strand.

Also according to the invention, an impregnated yarn is provided having at least two continuous strands comprising plant fibers, with a first individual twist of the strands in a first direction (each of said strands has an individual twist in a first orientation) and a second overall twist of the strands in a second direction different from the first direction (all of said strands have an overall twist in a second orientation different from the first orientation). Preferably, said strands are impregnated with thermoplastic material in at least 60% of their volume, each of said strands being individually twisted and all of said strands also being twisted into a configuration held by the thermoplastic material.

Thus, such an impregnated yarn thus exhibits both an individual strand twist and also an overall twist. It is understood that the thermoplastic material allows the formation of a bond between all the strands/filaments both in their individual twisted configuration (individual strand twist) and also in their twisted configuration together (overall twist of the strands resulting in a twisted yarn).

As will be presented in detail later, this results in an impregnated yarn with high mechanical performance. Among other things, such an impregnated yarn has improved bending, tensile and compressive strength due to this double level twist, for each strand and between all strands.

According to one embodiment, the impregnated yarn further comprises at least one binding wire helically wound around all of said strands, forming an impregnated and tied yarn. Such a binding wire improves the shape retention of the yarn section, and will in particular contribute to limit the crushing of the yarn intended to form a rib on the surface of a thin-walled composite product. This binding wire is therefore optional. If this binding wire is present around the impregnated yarn, two helically wound binding wires can be provided as an alternative, which can be in the same direction, or preferably in the opposite direction.

One or more of the following provisions may furthermore be present in the impregnated yarn:

the outer fibers of said strands form(s) an angle of between −20° and +20° with the longitudinal or main direction of the impregnated yarn,
the strands have an individual twist of between 50 and 300 tpm, preferably between 100 and 200 tpm,
the impregnated yarn comprises between three and six strands, each with a weight of between 200 and 800 tex, preferably between 300 and 600 tex.

Also, according to the invention, a process for manufacturing a thin-walled composite product is proposed comprising the following steps:

providing a support such as a mat,
manufacturing impregnated yarns according to the process described herein,
assembling the impregnated yarns to form a latticework in which the impregnated yarns intersect,
stacking the latticework and the support, and
compression molding the stacked latticework and support, whereby a composite product is formed, having a ribbed face, said ribs being created at least in part by the impregnated yarns.

Also according to the invention, a process for manufacturing a thin-walled composite product is proposed, comprising the following steps:

manufacturing impregnated yarns according to the process described herein,
providing base yarns having a size smaller than the impregnated yarns,
weaving or knitting the base yarns with said impregnated yarns, to form a preform,
compression molding the preform, whereby a composite product having a ribbed face is formed, said ribs being created at least in part by the impregnated yarns.

Further, according to the invention, a solution is provided whereby a thin-walled composite product is provided comprising impregnated yarns as described herein, said composite product having a ribbed face, said ribs being created at least in part by said impregnated yarns.

The presence of these ribs makes it possible to increase the flexural rigidity of the part formed of or incorporating such a thin-walled composite product, while slightly increasing its weight. The presence of these ribs also makes it possible to improve the impact behavior of this part, the ribs slowing down the propagation of cracks in the part during an impact, thus confining the damage, avoiding the projection of debris and increasing the absorption of energy on impact.

As used herein, the term “thin-walled” composite product means that the composite product has a wall thickness of no more than 10% of the smallest dimension of the composite product or the article comprising the composite product. Alternatively, within the scope of the present invention, the term “thin-walled” composite product means that the composite product has a wall thickness of no more than 5% of the smallest dimension of such composite product or article comprising such composite product.

The thin-walled composite product thus formed is intended to form in particular, and in a non-limitative way, a part or a portion of part for the interior of a motor vehicle, such as dashboard, door cover, pillar and console cover panel, a roof, a trunk cover. It can also be used to make suitcase shells, vehicle bodies. . . .

The invention also relates to a method of manufacturing an article comprising a thin-walled portion wherein said thin-walled portion is formed of or comprises a thin-walled composite product manufactured according to the method described herein, said article belonging to the group comprising:

an automotive body part, including doors, roof, hood, fenders, spoiler, front and rear bumpers, aerodynamic kits, or automotive interior parts including door covers, dashboard, center console, pillar trims, trunk trims, headliner, or sporting goods such as a canoe shell, kayak or light boat hulls, bicycle frames, or furniture parts, or aircraft interior parts, including side panels, ceiling panels, luggage compartments, or light aircraft aerodynamic parts, including engine cowlings, wheel covers, or any aerodynamic fairing of a mobile machine, or a suitcase shell.

### BRIEF DESCRIPTION OF THE FIGURES

Examples of implementation of the invention are shown in the description illustrated by the attached figures in which:

FIG. 1 illustrates the different steps of a manufacturing process of an impregnated yarn and the resulting impregnated yarn which are not part of the invention,

FIG. 2 shows the different steps of a manufacturing process of an impregnated yarn with two strands and the impregnated yarn resulting from this manufacturing process according to the invention,

FIG. 3 illustrates the various steps of a three-strand variant of the manufacturing process of an impregnated yarn and the resulting impregnated yarn according to the invention,

FIG. 4 shows a unit for manufacturing an impregnated yarn that allows the implementation of the variant of the manufacturing process shown in FIG. 3,

FIG. 5 shows schematically a possible implementation for the impregnation tank allowing the impregnation step of the strand or strands that will form the impregnated yarn,

FIGS. 6A and 6B show the first side and second side, respectively, of a ribbed thin-walled composite product according to the invention comprising impregnated yarns,

FIG. 7 is an enlarged view of area VII of FIG. 6B, showing the impregnated yarns forming ribs on one side of the composite product of FIGS. 6A and 6B, and

FIG. 8 illustrates the various steps of a manufacturing process forming another type of impregnated yarn and which is outside the scope of the present invention.

### EXAMPLE(S) OF EMBODIMENT OF THE INVENTION

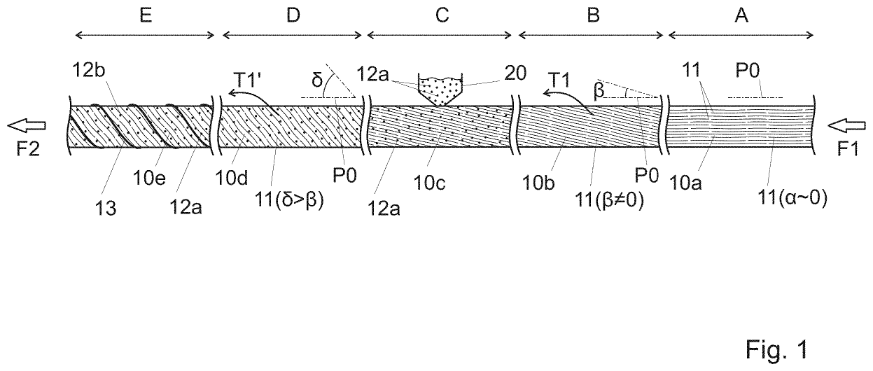

Reference is made to FIG. 1 showing the steps in the manufacture of an impregnated yarn that is not part of the invention, from the right to the left of FIG. 1, with arrow F1 representing the input and arrow F2 representing the output. Here, a single strand 10a is used to continuously form the impregnated yarn 10e. Initially (after arrow F1, step A), strand 10a is a continuous sliver coming off a spool and comprising plant fibers 11 whose orientation has not necessarily been directed. For example, this strand 10a consists of short flax/linen fibers that are essentially parallel to each other and to the general direction of the strand 10a. Then, (step B), preferably, but not necessarily, a twist T1 of the strand 10a in a first direction is performed, forming a twisted strand 10b according to an individual twist that orients the fibers 11 in a direction that is not parallel to the general direction P0 of the strand 10a (angle β for the outer fibers 11 in FIG. 1). The aim of this twist will be to increase the tear strength of the strand, and thus to avoid breakage during the next impregnation step. This individual twist T1 will, however, be small (for example, an angle β between 0° and 20° with respect to the direction P0 of the strand 10b) in order to facilitate good impregnation in the next step. According to another possibility (without step A in FIG. 1), one starts directly from the strand 10b already individually twisted on the spool that feeds the production line. Then, (step C), the twisted strand 10b (or the untwisted strand 10a) is impregnated with a liquid thermoplastic material 12a, such as a thermoplastic polymer (or a mixture of thermoplastic polymers) present in an impregnation tank 20. This specific impregnation step C will be described in detail below. An impregnated, possibly twisted, strand 10c is obtained, also forming, in this case of FIG. 1 with a single strand, an impregnated yarn 10e.

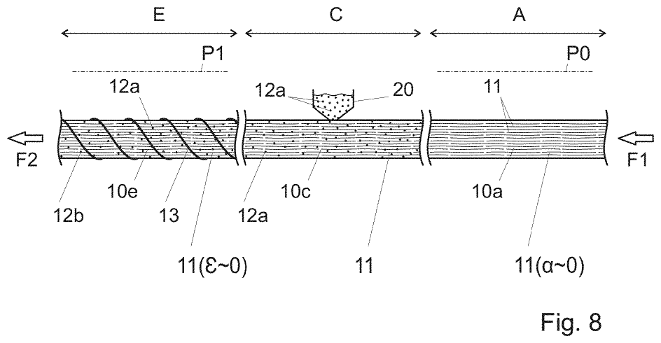

In the case of FIG. 8, which is not part of the invention, the alternative case has been shown in which the manufacturing process includes steps A, C described above, and step E described below, but not steps B and D: there is no individual twist T1, nor additional individual twist T1′. This FIG. 8 has a single strand 10a with fibers 11 essentially parallel to the direction P0 of the strand 10a, to form the impregnated yarn 10e, but it is possible, within the framework of this process of FIG. 8, to use two strands 10a, three strands 10a or even more strands 10e, which thus remain in their untwisted state throughout the process, and in particular during the impregnation step C and the (optional) tying step E.

Then, as shown in FIG. 1, at the outlet of the impregnation tank 20, but optionally and not imperatively, the yarn 10c can be twisted (step D), and this additionally if it has already been twisted before (step B of twist T1 or already provided twisted strand). This individual (additional) twist T1′, which takes place in the same direction (first twist orientation) as the individual twist T1, increases the radial compressive strength of the yarn, and this while the lower twist T1 (angle β)of the outer fibers 11 in the impregnation tank 20 facilitates good impregnation. A last step E, which is preferable but not imperative, in addition to or as an alternative to the twist T1′ (step D) of the yarn at the outlet of the tank, consists in placing a binding wire 13 around the twisted impregnated strand 10c, forming a helix, and this after the passage in the impregnation tank 20, while the thermoplastic material 12a which has impregnated the impregnated yarn is still liquid and has not completely hardened. The result is an impregnated and tied yarn 10e in which the cured thermoplastic material 12b serves as a binder to maintain the position and orientation of the fibers 11, on the one hand, between them and, on the other hand, with the binding wire 13, within the impregnated and tied yarn 10e, which has good cohesion, giving it good radial compression resistance properties. At the exit (arrow F2), an impregnated and tied yarn 10e has been formed which can be wound onto a spool for further use.

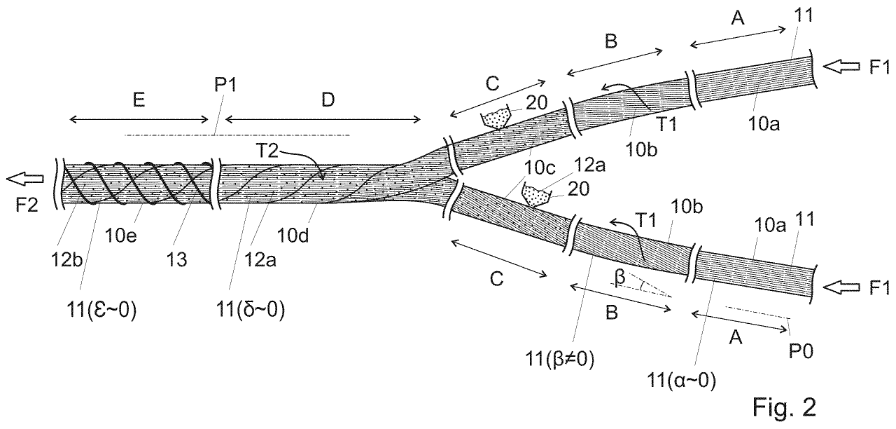

Reference is made to FIG. 2, which represents a variant of the process for manufacturing a single-strand impregnated yarn just described in connection with FIGS. 1 and 8, constituting a process falling within the scope of the invention, in which two strands 10a (step A) or 10b (step B) are used to form an impregnated yarn according to the invention. Each twisted strand 10b is impregnated with liquid thermoplastic material 12a in the impregnation tank 20 (step C) and then the two impregnated twisted strands 10c are twisted together with a twist T2. In this way, an impregnated yarn 10d is formed that is larger than each individual impregnated twisted strand 10c, and this while the thermoplastic material is still liquid 12a, in any case not cured. In this way, this thermoplastic material makes a bond between the two impregnated twisted strands 10c, which maintains in the impregnated yarn 10d the configuration of the overall twist between the two impregnated twisted strands 10c. In the optional, but preferred, final step E of laying the helical bonding wire 13 around the impregnated strand 10d, because the thermoplastic material 12a is still liquid and has not fully cured, it also makes a bond holding the helical bonding wire 13 around the impregnated yarn 10d together, and to form an impregnated and twisted yarn 10e. Once the thermoplastic material 12b is cured, it maintains these bonds.

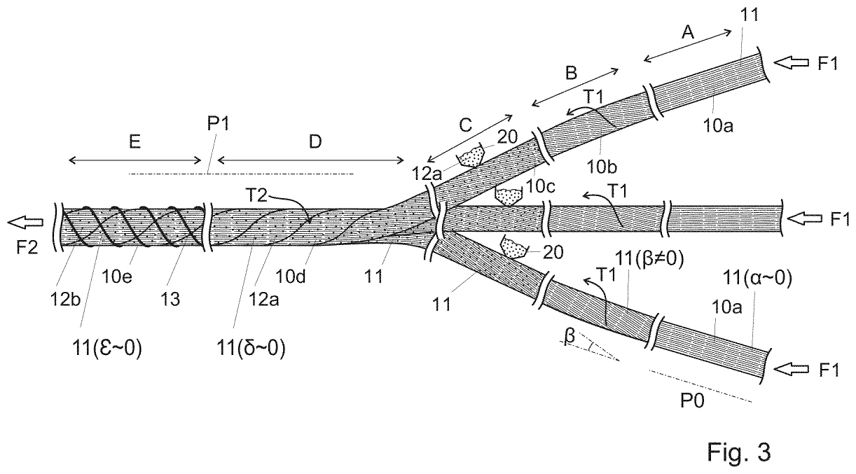

Reference is now made to FIG. 3 representing a variant of the process for manufacturing an impregnated yarn according to the invention, in which three flat strands 10a (step A) or three twisted strands 10b (step B) are used to form the impregnated yarn. Each twisted strand 10b is impregnated with liquid thermoplastic material 12a at the impregnation tank (step C) and then the three impregnated twisted strands 10c are twisted together (step D) in an overall twist T2. In this way, an impregnated yarn 10d is formed that is larger than each individual impregnated twisted strand 10c, and this while the thermoplastic material is still liquid 12a, in any case not cured. In this way, this thermoplastic material 12 provides a bond between the three impregnated twisted strands 10c, which maintains the overall twist pattern between the three impregnated twisted strands 10c in the impregnated yarn 10d. If a helical binding wire 13 is used around the impregnated yarn 10d, as shown in FIG. 3, while the thermoplastic material 12a is still liquid and has not fully cured, this thermoplastic material 12a not only provides a bond between the three impregnated twisted strands 10c of the impregnated yarn 10d, but also provides a bond retaining the helical binding wire 13 around the impregnated yarn 10d, and to form an impregnated and tied yarn 10e. Once the thermoplastic material 12b is cured, it maintains these bonds.

The cases in which the impregnated yarn is made of a single strand, two strands or three strands have just been described in relation to FIGS. 1, 8, 2 and 3, but it is understood that according to the invention, it is possible to use even more strands twisted individually and twisted together (four strands, five strands or more strands).

Note that the expression “impregnated and tied yarn” may be replaced by “impregnated yarn” and vice versa in the present text because the use of the binding yarn 13 arranged in a helix around the impregnated yarn is not systematic in the context of the present invention.

We refer to FIG. 5 illustrating one of the possibilities of implementing the impregnation step, with the impregnation tank 20 filled with liquid thermoplastic material 12a and delimiting a passage 21 between the inlet 20a and the outlet 20b of the impregnation tank 20. According to an essential provision to allow the good impregnation of the strands 10b by the liquid thermoplastic material 12a, there exists in the passage 21 followed by each of the twisted strands 10b, one or more contact zone(s) 20c with a wall belonging to the face of the passage 21, thus of the internal face of the impregnation tank 20. In the figure shown in FIG. 5, these contact zones 20c are located on the lateral face of the cylinders 22 placed in the impregnation tank 20 and bypassed by the twisted strands 10b which thus run through a wave-shaped passage 21. Other configurations not shown are possible to force the individual contact of the twisted strands 10b against a face of the passage 21 while the strands 10b are immersed in the liquid thermoplastic material 12a, for example with zig-zag walls of the impregnation tank 20. Generally speaking, the passage 21 is sinuous.

Thus, it is understood that because of this friction and the pressure of the twisted strands 10b on these contact zones, the penetration of the liquid thermoplastic material 12a into the strand 10b is favored, and this in particular because this contact tends to move the fibers 11 of the twisted strands 10b apart from each other and to create a local overpressure on the liquid thermoplastic material 12a. At the exit of the passage 21 and of the aforementioned contacts, impregnated twisted strands 10c are obtained with an individual twist T1 conforming to that before the passage in the impregnation tank, these strands being highly impregnated or even entirely impregnated with thermoplastic material 12a. Thanks to this arrangement, an effective impregnation step is carried out which makes it possible to have impregnated strands 10c at the outlet of the impregnation tank 20 with an impregnation of thermoplastic material in at least 60% of their volume, in general in at least 70% of their volume, preferably in at least 80%, or even at least 90% or 95%. In some cases, it is possible to obtain an impregnation of thermoplastic material in all (100%) the volume of the impregnated strands 10c. This large quantity of thermoplastic material is found in this same proportion in the yarn at the end of the manufacturing line implementing the manufacturing process according to the invention.

In an embodiment corresponding to FIG. 3, each of said strands has a twist T1 according to a first orientation when they pass through the impregnation tank 20: this individual twist is for example between 50 and 300 tpm, preferably between 100 and 200 tpm. This first orientation is for example S-shaped. This first orientation of the twist T1 results in the formation of a strand 10b with outer fibers 11 that present an angle β with respect to the general direction P0 of the strand 10a.

According to the invention, said impregnated yarn 10d comprises at least two twisted strands 10b (preferably three twisted strands 10b) separated from each other upstream of the impregnation tank 20 and passing simultaneously through said passage 21. For example, the impregnated yarn 10d is composed of 2 to 10 individual strands of 200 to 1500 tex, preferably 3 to 6 strands of 200 to 800 tex, preferably 3 to 6 strands of 300 to 600 tex. According to an alternative embodiment, several separate impregnation tanks working in parallel are used, one for impregnating each strand 10b.

For example, the twisted strands 10b enter the impregnation tank through a calibrated hole at the inlet 20a of the impregnation tank 20 (on the right in FIG. 5), large enough to avoid blockage, but small enough to avoid leakage of liquid thermoplastic material, e.g., polypropylene (e.g., a hole of 2.5 mm diameter for three twisted strands 10b of 555 tex each). Also, for example, the impregnated twisted strands 10c emerge through a calibrated hole at the outlet 20b of the impregnation tank 20 (on the left in FIG. 5) which will determine the final radius of the impregnated yarn 10d and the amount of thermoplastic material of this impregnated yarn 10d. (example a hole of 2 mm diameter for three twisted strands 10b of 555 tex each). The diameter of this exit hole will be adjusted to obtain the desired fraction of thermoplastic material and fiber in the impregnated yarn 10d. The fraction will typically be between 30 and 70 wt % thermoplastic material, preferably between 40 and 60 wt % thermoplastic material in the impregnated yarn 10d.

According to one embodiment, the sole strand 10a or 10b or each strand 10a or 10b consists solely of vegetable fibers. These vegetable fibers belong to the group comprising the following materials: flax, hemp, sisal, jute, abaca, kenaf, nettle, ramie, kapok, abaca, henequen, pineapple, banana, palm, and wood fiber.

According to one embodiment, the thermoplastic material used for impregnation comprises a polymer which belongs to the group comprising polyolefins, polypropylene (PP), maleic anhydride grafted polypropylene (maPP), polyethylene (PE) polyamide or co-polyamide, polyester or co-polyester, thermoplastic polyurethane, co-polyoxymethylene, thermoplastic cellulose esters (cellulose acetate propionate), polylactic acid (PLA) or derivatives thereof or a mixture thereof. For example, a mixture of polypropylene and polypropylene grafted with maleic anhydride (maPP) is used, which favors the adhesion of the polymer with the natural fibers. For example, such a mixture can be used with 3 to 10% maPP by weight.

According to one embodiment, the thermoplastic material has a viscosity in the impregnation tank 20 such that the Melt Flow Index is greater than 10 g/10 min, preferably greater than 34 g/10 min. By Melt Flow Index is meant a measurement in g/10 min, according to the ISO 1133 standard, under a load of 2.16 kg at 230° C.

According to one embodiment, the molten thermoplastic material 12a has a viscosity in the impregnation tank 20 of between 10 and 10,000 Pa·s, preferably between 20 and 1000 Pa·s, and preferably between 50 and 500 Pa·s. This viscosity corresponds to a low shear rate viscosity of 1 sec-1. Generally, the temperature of the thermoplastic material during impregnation in the impregnation tank 20 is between 150° C. and 250° C.

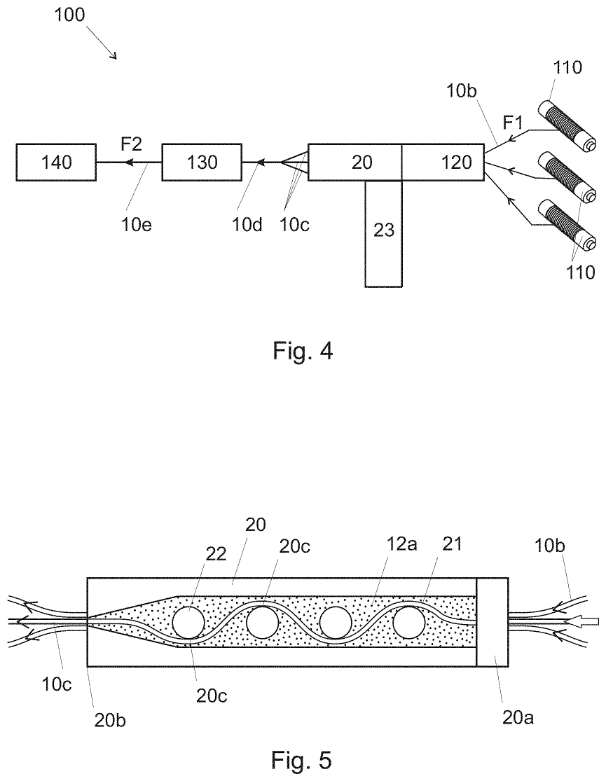

In order to implement the process for manufacturing an impregnated yarn as described above, in particular in relation to FIGS. 1 to 3, a manufacturing unit 100 can be used as illustrated schematically in FIG. 4. The direction of advance from right to left in FIGS. 1 to 3 is found again, between an inlet F1 and an outlet F2. At the input of this manufacturing unit 100, three reels 110 allow the feeding of the manufacturing unit 100 with three twisted strands 10b corresponding to step B of FIG. 3.

In the case shown, the twisted strands 10b are dried by passing through a drying module 120, which drying could be omitted in other implementation variants. However, it can be seen that the natural fibers still have 4-8% moisture content. When these fibers 11 enter the impregnation tank, which is heated to 190° C. for example, this moisture forms water vapor and escapes from the fibers. As the steam escapes, it displaces the thermoplastic material and impairs the impregnation of the fibers forming the strands. The twisted strands 10b can be dried very easily by passing through a drying module 120, which consists of a tube with a hot air flow between 100-150° C., before entering the impregnation tank. It is also possible to dry the twisted strands 10b beforehand and to keep the coils unwinding on the reels 110 in a dry atmosphere.

In this way, prior to the entry into the impregnation tank 20 of the strand 10b or said strands 10b, the drying of said strand 10b or said strands 10b is performed.

The previously described impregnation tank 20 is arranged immediately downstream of the drying module 120, with an extruder 23 feeding liquid thermoplastic material to the tank 20.

The end of the manufacturing unit 100 comprises, downstream of the impregnation tank 20, a driving, winding and twisting module 140 comprising a spool for receiving the impregnated yarn 10d (or the impregnated and tied yarn 10e). In this way, when the free end of the impregnated yarn 10d is passed through the driving, winding and twisting module 140, and said driving, winding and twisting module 140 is activated, the impregnated yarn is advanced and twisted as a whole and wound onto a support as the impregnated yarn advances, thereby obtaining a twisted (and possibly tied) impregnated yarn 10d which is wound onto a spool of the driving, winding and twisting module 140.

In this way, after the impregnation step C, a step (step D) of twisting the impregnated yarn 10d is carried out, during which an overall twist corresponding to a T2 twist between them of all the strands downstream of the impregnation tank 20 is carried out, while the thermoplastic material is still in the liquid state, whereby the thermoplastic material 12a achieves a bond between the strands 10c in their twisted together state, resulting in the formation of an impregnated and twisted yarn 10d.

According to the invention, the overall twist is carried out in a second orientation T2 different from the first orientation T1. Thus, if the individual twist T1 of each strand 10c is in the S direction (counterclockwise with respect to the direction of advance of the yarn), an overall twist of the yarn 10d in the Z direction (clockwise with respect to the direction of advance of the yarn) will be carried out with the said driving, winding and twisting module 140.

With these provisions, the degree of twist T2 is chosen so that the outer fibers 11 of said strand 10c or strands 10c form an acute or zero, small angle 5 between −20° and +20° with the longitudinal or main direction P1 of the impregnated yarn 10d. According to another possibility, this angle δ is between +10° and −10°, or even between +5° and −5° and possibly between +3° and −3°. By “outer fibers” is meant the portion of the fibers of each strand that is located on the surface of the impregnated (and twisted) yarn. Indeed, in cases where the strands 10b have fibers with a certain twist according to a first orientation (angle δ if cumulative twists T1 and T1′, or angle β if twist T1 only), by twisting the strands together according to a second orientation (overall twist T2), the angle δ (and possibly ε in the presence of a binding wire 13) formed between the outer fibers of the strands and the main direction P1 of the yarn 10d or 10e is reduced, or even cancelled. This can be seen in particular in FIG. 3, where the fibers 11, visible in the portion D representing the impregnated yarn 10d with overall twist, and forming outer fibers, are substantially parallel to the main direction P1 of the impregnated yarn 10d (angle ε noted as close to 0, i.e., ε˜0, with respect to P1).

This situation, in which the outer fibers 11 are oriented at 0° (longitudinal) in the impregnated yarn 10d, results in impregnated yarns that are maximally rigid in bending, which will result in good bending strength qualities when these yarns are integrated as surface ribs in a thin-walled composite product.

Since the outer fibers of the impregnated yarn are mainly stressed in bending, a yarn geometry with the outer yarn fibers at 0° (longitudinal) is advantageous. This is possible by twisting (T2 twist) several individual yarns in a twist direction opposite to the individual strands (if the individual strands have an S twist T1, the yarn is twisted in Z for the T2 twist) so that the outer fibers are at or near 0°. For example, twisting with a 73 tpm twist three individual strands of 555 tex having a 158 tpm twist results in a fiber angle of 0° on the outside of the 1665 tex yarn (e.g., linen). Thus, by working with individual strands twisted to form a large yarn, it is possible to optimize the fiber angle 11 to have good bending properties (outer fiber 11 at 0°) and good radial compressive strength of the yarn (inner fiber 11 with a large enough twist angle).

Because the step D operation of twisting all of the individual yarns 10c into a larger yarn 10d is performed while the thermoplastic material 12a is still in a molten state, this overall twist creates additional compaction of the yarn 10d that further presses the thermoplastic material into the interior of the individual yarns 10c and enhances its impregnation.

In the embodiment shown in FIGS. 1 to 3, the following step is carried out (step E): a binding wire 13 is provided and said binding wire 13 is wound around the impregnated yarn 10d of thermoplastic material downstream of the impregnation tank, thereby forming an impregnated and tied yarn 10e. This binding wire 13 is laid in a helix all around the impregnated yarn 10d while the thermoplastic material 12a is still liquid in order to ensure the fixing of this binding wire 13 on the impregnated yarn 10d and to obtain a good cohesion for the impregnated and tied yarn 10e. For example, this binding wire has a linear weight between 10 and 60 tex, preferably between 15 and 45 tex. The weight added by the binding wire will typically be from 1 to 15% of the total weight of the impregnated and tied yarn 10e, preferably from 2 to 10%.

Among the advantages of the presence of this binding wire 13, it should be noted that it contributes to maintaining a circular shape to the cross-section of the impregnated and tied yarn 10e, and principally to increasing its resistance to radial compression. This is advantageous when the impregnated and tied yarn 10e is used in a thin-walled composite product as ribs on its surface, because during the manufacturing process of the thin-walled composite product the product is compressed, either by a flexible membrane under pressure or by a flexible pad (e.g. a silicone substrate). During this process, the threads of the ribs tend to be crushed and the effectiveness of the ribs is thus reduced. Since the stiffness in bending stress depends on the thickness of the structure to the power of three, the thickness of the ribs has a dominant influence on the bending stiffness of the thin-walled composite product.

The binding wire 13 can be a vegetable fiber yarn (e.g. flax/linen, cotton, hemp . . . ) or can be synthetic (polymer yarn such as polyester, polyamide, or glass fibers, carbon fibers, aramid). This binding wire 13 must not melt or become too flexible at the processing temperature of the composite product (180-210° C.), otherwise the binding wire 13 will deform when the part is compressed and it loses all its usefulness in confining and maintaining the shape of the impregnated and tied yarn 10e.

Thus, if a twisted binding wire 13 is present in the impregnated yarn 10e, this binding wire 13 is laid down (step E) after the step D of twisting the yarn as a whole, while the binding wire laying module 130 is arranged upstream of (before the) driving, winding and twisting module 140. It is understood that the twisting (overall twist T2) of all the yarn strands is carried out by the driving, winding and twisting module 140, but that this overall twisting is propagated as far as the outlet of the impregnation tank 20 (in FIG. 4, at the outlet—on the left—of the impregnation tank 20, the three twisted impregnated strands 10c are differentiated (separated) and are then combined in the impregnated yarn 10d).

According to an unillustrated embodiment, at least two binder wires 13 are provided downstream of the impregnation tank, and said binder wires are continuously arranged helically with different directions around the impregnated yarn 10d as it advances through the outlet of the impregnation tank, whereby an impregnated and tied yarn 10e is formed. In one embodiment, exactly two binding wires 13 are arranged helically around the impregnated yarn 10d with a reverse direction of rotation, whereby the two binding wires 13 intersect at the surface of the impregnated and tied yarn 10e.

For the installation of this binding wire 13 or two or more binding wires 13, different methods are possible. In a first solution, the impregnated yarn is passed inside the binding wire spool, said spool rotating at the speed determined to achieve the desired binding wire density. As the spool rotates at high speed, the tension on the small binding wire is generated by the inertia of this binding wire rotating at high speed around the impregnated yarn. Alternatively, the spool of binding wire can rotate around the impregnated yarn, and the tension in the binding wire is generated by braking the unwinding of the spool. In either case, the impregnated yarn has no contact with the binding wire delivery unit other than the binding wire itself, and this is so as not to interfere with the twisting process that takes place between the driving, winding and twisting module 140 and the impregnation tank 20.

For the driving, winding and twisting module 140, a winding system can be used where the spool that winds the impregnated yarn rotates both on its own axis to wind the impregnated yarn, and on the axis of the impregnated yarn to create twist. The second way is the spinning wheel way, with the flyer rotating around the spool. The rotational speed of the flyer determines the twist, and the speed differential between the spool and the flyer controls the feed rate of the impregnated yarn. The precise control of these two speeds can be done with stepper motors, synchronous motors or servo motors.

According to another possibility visible in FIG. 8, which is not part of the present invention, the initial strand 10a is in the form of a ribbon with aligned fibers 11, with fibers 11 having an angle close to 0° with respect to the main direction P0 of the ribbon or sliver, passing through the bath of molten thermoplastic polymer in an impregnation tank before the binding wire 13 is laid helically around the impregnated yarn 10c.

As previously indicated, the invention also relates to a thin-walled composite product comprising impregnated yarns as previously described, said composite product having a ribbed face, said ribs being created at least in part by said impregnated yarns, and in some cases all of the ribs being formed by impregnated yarns.

According to one possibility, such a ribbed thin-walled composite product results from a process comprising the following steps:

providing a support such as a mat,
manufacturing impregnated yarns according to the previously described process,
assembling the impregnated yarns to form a latticework in which the impregnated yarns intersect,
stacking the latticework and the support, and
compression molding the stacked latticework and support, whereby a composite product is formed, having a ribbed face, said ribs being created at least in part by the impregnated yarns.

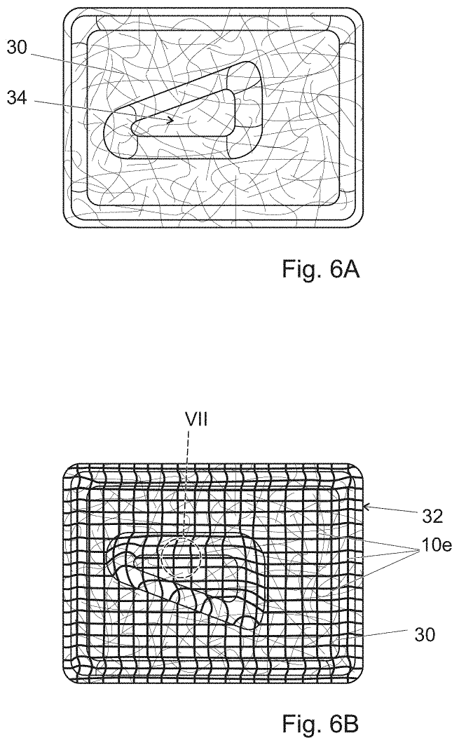

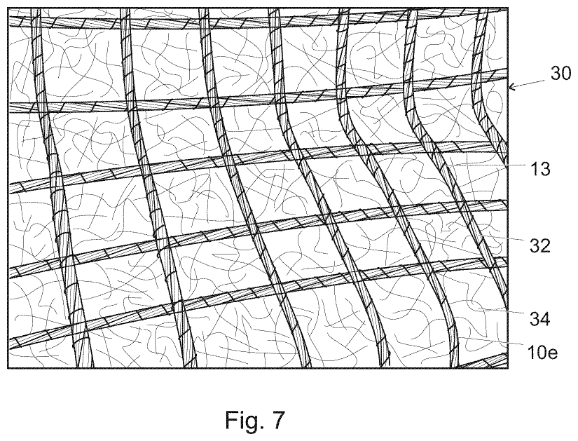

An example of such a thin-walled ribbed composite product 30 is illustrated in FIGS. 6A and 6B and in FIG. 7 in the form of a portion of a part that can be used, for example, as a trim part for an automobile interior. This thin-walled ribbed composite product 30 comprises a latticework 32 and a support 34 superimposed and connected to each other. The latticework 32 is formed of impregnated and tied yarns 10e which are held together in an interlocking fashion by a assembling wire, for example of polyester, for example a 10 to 100 dtex wire, applied by sewing, knitting or weaving with the impregnated and tied yarns 10e of the latticework 32.

The bond between the latticework 32 and the support 34 is made by the polymer itself, either during the compression molding step or during a hot pre-lamination step. Alternatively, the latticework 32 can be sewn onto the substrate 34.

According to another manufacturing method, two supports 34 are provided and the latticework 32 is stacked with the two supports 34, with the two supports 34 on either side of said latticework 32 to form a sandwich stack.

According to an embodiment, the support 34 (or both supports) is (are) selected from a support of woven material, a support of non-woven material or, a support 34 of non-woven material belonging to the following list: a unidirectional fiber web (11), a superposition of unidirectional fiber webs (11) (multidirectional web), and a mat of randomly distributed fibers.

According to one embodiment, said substrate 34 (or both substrates) is (are) pre-impregnated with a polymer (or more generally a thermoplastic material) that is the same as or different from the polymer (or more generally the thermoplastic material) of the impregnated yarns of the latticework.

According to one embodiment, the latticework 32 comprises a mesh with a mesh opening greater than or equal to 1 cm, preferably between 1 cm and 6 cm, preferably between 1 cm and 3 cm.

The impregnated yarn described above is used to form a latticework 32 or grid. The grid may have parallel yarns in two directions to create a square, rectangular, or parallelepipedic mesh. It can also have three or four yarn directions. A square mesh grid will typically have a mesh size of 5-100 mm, depending on the size of the yarn used, typically 10-30 mm mesh with a 1500 tex impregnated linen yarn. The grid can be made by a textile method, with a small thread binding the impregnated yarns together, for example by knitting. The grid can also be obtained by thermally welding the impregnated yarns at their crossings, either by heating or by ultrasound. To obtain the desired final composite product, the grid is then combined with other composite layers in the thermocompression step (e.g. mats of natural fibers and PP, or mats of polyester fibers and PP. . . . )

According to another possibility, a process for manufacturing a ribbed thin-walled composite product is proposed, comprising the following steps:

manufacturing impregnated yarns according to one of the previously described processes,
providing base yarns having a size smaller than the impregnated yarns
weaving or knitting the base yarns with said impregnated yarns to form a preform,
compression molding the preform, whereby a composite product with a ribbed face is formed, said ribs being created at least in part by the impregnated yarns.

The preform with the impregnated wires has to be shaped in order to obtain said composite product with reinforcing ribs. Several methods are possible. For thermocompression, the preform is heated in an oven to melt the thermoplastic polymer. The base layer and the preform comprising the impregnated yarns can either be pre-combined and heated together, if their temperature and heating method match, or heated separately but simultaneously. The preform and the base layer are placed in the mold in a press and the press is closed to compact and form the composite product. Once the polymer has cooled and cured, the part is demolded. The mold used is rigid on the smooth side of the part, but has a soft substrate, such as a 2-10 mm layer of silicone, on the ribbed side, so as not to crush the ribs created by the impregnated yarns 10d or 10e described earlier. Alternatively, pressure can be exerted by a flexible membrane pressurized on the ribbed side. Also, the heating and cooling cycle can be done in the mold

The ribs can be obtained at specifically selected locations using a deposition robot that will precisely deposit the desired impregnated yarns 10d or 10e on a base layer (e.g., mat), according to a specific reinforcement pattern. The bonding to the base layer can be done by melting the polymer, or by locally sewing the impregnated yarn.

The composite product presented here is thin-walled, which means that it is usually initially in the form of a sheet or panel with one dimension much smaller (at least 10 times smaller) than the other two.

Such a composite product can have a variety of geometries, including a flat sheet, a non-planar sheet, including a sheet with a convex and a concave side, or a corrugated sheet, a three-dimensional hollow shape, including a hollow tube with a circular cross-section, a polygonal cross-section, or another shape, including any three-dimensional thin-walled shell.

Thus, and in a non-limiting manner, it is proposed to manufacture an article comprising a thin-walled portion wherein said thin-walled portion is formed of a thin-walled composite product manufactured according to one of the previously described processes. Such an article incorporating a thin-walled composite product is usable in various applications and in particular belongs to the group comprising:

a car body part, in particular the doors, the roof, the hood, the fenders, the spoiler, the front and rear bumpers, the aerodynamic kits, or car interior parts, in particular the door covers, the dashboard, the central console, the pillar linings, the trunk linings, the roof, or sports articles such as a canoe hull kayak or light boat hulls, bicycle frames, or furniture parts, or aircraft interior parts, including side panels, ceiling panels, luggage compartments, or light aircraft aerodynamic parts, including engine cowlings, wheel covers, or any aerodynamic fairing of a mobile machine, or a suitcase shell.

[Tables 1]

### Reference Numbers used on Figures

A Strand(s) 10a feeding step
B Twisting step of the strand(s) 10a
C Impregnation step of the strand(s) 10b
D Twisting step of the whole strands 10c
E Step of laying the bonding wire 13 on the yarn 10d
F1 Input
F2 Output
T1 Individual strand twisting
T1′ Additional individual strand twisting
T2 Overall yarn twist
P0 Main direction of the strand
P1 Main direction of the yarn
A Angle between the outer fibers 11 and the strand 10a (step A)
B Angle between the outer fibers 11 and the strand 10b (step B)
Δ Angle between the outer fibers 11 and the impregnated and twisted yarn 10d (step D)
E Angle between the outer fibers 11 and the impregnated, twisted and tied yarn 10e (step E)
10a Flat strand
10b Twisted strand
10c Twisted impregnated strand (impregnated yarn if only one strand)
10d Impregnated yarn with overall twist
10e Impregnated and tied yarn
11 Fibers
12a Liquid thermoplastic material
12b Hardened thermoplastic material
13 binding wire
20 Impregnation tank
20a Tank inlet
20b Tank outlet
20c Contact area of the strands in passage 21
21 Passage
22 Cylinder
23 Extruder
30 Thin-walled ribbed composite product
32 Latticework
34 Support
100 Manufacturing unit
110 Reels
120 Drying module
130 Binding wire laying module
140 Driving, winding and twisting unit

1. A method of manufacturing an impregnated yarn from at least two strands comprising vegetable fibers, wherein the following steps are carried out:
providing at least two continuous strands comprising vegetable fibers,
providing an impregnation tank delimiting a sinuous passage between an inlet and an outlet,
feeding the tank with a bath of molten thermoplastic polymeric material filling said passage permanently,
arranging said strands so that they are separated from each other upstream of the impregnation tank, so that they enter the impregnation tank through said inlet, so that they simultaneously follow the passage while being immersed in the thermoplastic material and having at least one zone of contact with one face of the passage, and so that they leave the impregnation tank through said outlet, and
impregnating the strand wherein by continuously advancing said strand so as to form a strand impregnated with the thermoplastic material, whereby an impregnated yarn is formed;
wherein each of said strands has a twist (T1) in a first orientation during their passage through the impregnation tank, and
wherein, after the impregnation step, a yarn twisting step is further carried out, during which an overall twist corresponding to a twist (T2) between them of all the strands is carried out, downstream of the impregnation tank, while the thermoplastic material is still in the liquid state, whereby the thermoplastic material makes a connection between the strands in their twisted together state, resulting in the formation of an impregnated and twisted yarn, and wherein said overall twist (T2) is performed in a second orientation different from the first orientation.

2. A method of manufacturing an impregnated yarn according to claim 1, wherein the following step is further carried out:
providing a binding wire and winding said binding wire around the impregnated yarn of thermoplastic material downstream of the impregnation tank, whereby an impregnated and tied yarn is formed.

3. Method of manufacturing an impregnated yarn according to claim 1, wherein the outer fibers of said strand or strands form(s) an angle (δ) between −20° and +20° with the longitudinal or main direction of the impregnated yarn, preferably an angle (δ) between +10° and −10°, and more preferably an angle (δ) between +5° and −5°.

4. A method of making an impregnated yarn according to claim 1, wherein said strand consists solely of vegetable fibers.

5. A method of manufacturing a yarn according to claim 4 wherein the plant fibers belong to the group comprising the following materials: flax, hemp, sisal, jute, abaca, kenaf, nettle, ramie, kapok, abaca, henequen, pineapple, banana, palm, and wood fibers.

6. A method of manufacturing a yarn according to claim 1, wherein the thermoplastic polymer belongs to the group comprising polyolefins, polypropylene (PP), maleic anhydride grafted polypropylene (maPP), polyethylene (PE) polyamide or co-polyamide, polyester or co-polyester, thermoplastic polyurethane, co-polyoxymethylene, thermoplastic cellulose esters (cellulose acetate propionate), polylactic acid (PLA) or derivatives thereof or a mixture thereof.

7. Process for manufacturing a yarn according to claim 1, in which the thermoplastic material has, in the impregnation tank, a viscosity such that the Melt Flow Index, measured according to the ISO1133 Standard, under a load of 2.16 kg at 230° C., is greater than 10^{g}/10 min, preferably greater than 34^{g}/10 min.

8. A method of making a yarn according to claim 1, wherein the molten thermoplastic material has a viscosity in the impregnation vessel of between 10 and 10,000 Pa·s.

9. Process for manufacturing a yarn according to claim 1, in which, prior to the entry of the yarn into the impregnation tank, the said yarn is also dried.

10. Method of manufacturing a yarn according to claim 1, wherein the following steps are further performed:
providing at least two binding wires downstream of the impregnation tank,
continuously arranging said binding wires in a helix, with different directions, around the impregnated yarn as it advances through the outlet of the impregnation tank, whereby an impregnated and tied yarn is formed.

11. A method of manufacturing a yarn according to claim 1, wherein the following steps are further performed:
providing a driving, winding and twisting module disposed downstream of the impregnation tank,
passing the free end of the impregnated yarn into the driving, winding and twisting module, and
activating said driving, winding and twisting module to advance the impregnated yarn and to carry out its overall twist (T2) as well as its winding onto a support as the impregnated yarn advances.

12. A method of making a thin-walled composite product comprising the steps of:
providing a support such as a mat
making impregnated yarns according to the method of claim 1,
assembling the yarns wires to form a latticework in which the impregnated yarns intersect,
stacking the latticework and the support, and
compression molding the stacked latticework and support, thereby forming a composite product, having a ribbed face, said ribs being created at least in part by the impregnated yarns.

13. A method of making a thin-walled composite product according to claim 13, wherein the yarns of the latticework are held together in an intersecting fashion by a assembling wire, for example of polyester, applied by sewing, knitting or weaving with the yarns of the latticework.

14. A method of making a thin-walled composite product according to claim 13, wherein two supports are provided and the latticework is stacked with the two supports, the two supports being on opposite sides of said latticework to form a sandwich stack.

15. A method of making a thin-walled composite product according to claims 13, wherein the support is selected from a support of woven material or a support of non-woven material from the following list: a unidirectional fiber web, a superposition of unidirectional fiber webs (multidirectional web) and a mat of randomly distributed fibers.

16. A method of manufacturing a thin-walled composite product comprising the following steps:
manufacturing impregnated yarns according to the method of claim 1,
providing base yarns having a size smaller than the impregnated yarns,
weaving or knitting the base yarns with said impregnated yarns, to form a preform,
compression molding the preform, whereby a composite product having a ribbed face is formed, said ribs being created at least in part by the impregnated yarns.

17. A method of manufacturing an article comprising a thin-walled portion wherein said thin-walled portion is formed of or comprises a thin-walled composite product manufactured according to the method of claim 13, said article belonging to the group comprising:
an automotive body part, including doors, roof, hood, fenders, spoiler, front and rear bumpers, aerodynamic kits, or automotive interior parts including door covers, dashboard, center console, pillar trims, trunk trims, headliner, or sporting goods such as a canoe hull, kayak or light boat hull, a bicycle frame, or a piece of furniture, or aircraft interior parts, including side panels, ceiling panels, luggage compartments, or light aircraft aerodynamic parts, including the engine cowling, wheel covers, or any aerodynamic fairing of a mobile machine, or a suitcase shell.

18. An impregnated yarn having at least two continuous strands comprising plant fibers, said strands being impregnated with thermoplastic material in at least 60% of their volume, each of said strands being individually twisted, having a twist (T1) in a first orientation, and all of said strands also being twisted in a configuration held by the thermoplastic material, in an overall twist (T2) in a second orientation different from the first orientation.

19. An impregnated yarn according to claim 19, further comprising at least one binding wire helically wound around all of said strands, forming an impregnated and tied yarn.

20. The impregnated yarn according to claim 19, wherein the outer fibers of said strands form an angle (δ) between −20° and +20° with the longitudinal or main direction (P1) of the impregnated yarn, preferably an angle (δ) between +10° and −10°, and most preferably an angle (δ) between +5° and −5°.

21. The impregnated yarn according to claims 19, wherein the strands have an individual twist (T1) between 50 and 300 tpm, preferably between 100 and 200 tpm.

22. Impregnated yarn according to claim 19, comprising between three and six strands each having a weight of between 200 and 800 tex, preferably between 300 and 600 tex.

23. A thin-walled composite product comprising impregnated yarns according to claim 19, said composite product having a ribbed face, said ribs being created at least in part by said impregnated yarns.

24. Method of manufacturing a yarn according to claim 1, in which the impregnated yarn comprises between 30 and 70% by weight of thermoplastic material.
